(19) United States
(12) Patent Application Publication
(10) Pub. No.: US 2021/0400889 A1
(43) Pub. Date: Dec. 30, 2021

(54) Universal Identifier

(71) Applicants: Justin Wallace, Anderson, CA (US); William Butler, Anderson, CA (US); Greg Hamby, Anderson, CA (US)

(72) Inventors: Justin Wallace, Anderson, CA (US); William Butler, Anderson, CA (US); Greg Hamby, Anderson, CA (US)

(21) Appl. No.: 16/910,802

(22) Filed: Jun. 24, 2020

(51) Int. Cl. A01G 23/099; G09F 3/20; G06F 11/10; H04W 4/029

(52) U.S. Cl. CPC A01G 23/099; H04W 4/029; G06F 11/1044; G09F 3/206

(57) ABSTRACT

A disclosed plant identification (PID) pin includes a push pin flat stock base having a central ratchet defining a hole for a pin and defining a screen for an identification number. A knob includes a pointer and defines an opening coincident with the flat stock base hole and configured complementary to the central ratchet. A partial disk rotates around the pin and includes an identification number (IDN) on a face thereof and a boss coincident with the flat stock base hole. Additionally, a pin is designed to push through the flat stock base, the boss of the partial disk and into a tree and anchor the push pin into a woody stock of a plant. A passive electronic identification circuit with the identification number responds to GPS location queries. A seal on the flat stock base is broken via the pin to initiate the IDN for a certain woody plant.

### BACKGROUND

Tree marking is widely used in wildland fire suppression as a navigational aid for firefighters. When walking to a wildfire a crew may use flagging to flag their way to the fire, both to aid other firefighters in quickly finding the site and so they can find their way back out easily. Specially marked flagging also exists for fire use, imprinted with terms such as “spot fire” or “escape route”.

An associated practice of tree flagging is used in surveying to mark grade levels, utility lines, survey stakes and other boundary markers. Surveyors frequently attach their flagging to wooden stakes or lathes, and even trees with writing on it. One side tends to have a long number which they reference in a log book. The other side tends to have abbreviations suggesting what the stake marks. Choice of color depends on many factors, and can include availability, and personal preference, or may adhere to some sort of color code. No color codes appear to be mandatory or universal, but certain colors do tend to be used for specific purposes.

Trail blazing or way marking is the practice of marking paths in outdoor recreational areas with signs or markings that follow each other at certain, though not necessarily exactly defined, distances and mark the direction of the trail. A blaze in the beginning meant “a mark made on a tree by slashing the bark.” Originally a waymark was “any conspicuous object which serves as a guide to travellers; a landmark.” There are several ways of marking trails: paint, carvings, affixed markers, posts, flagging, cairns, and crosses, with paint being the most widely used.

Tree marking is also used for pest control to identify trees which are infested with insects and or disease. Tree marking can identify trees needing treatment, removal or transfer to better growing conditions.

However, the above are either destructive to a tree or not very practical in terms of modern electronics and modern needs for tree management and control. A more modern and less invasive device and method are needed in the marketplace of ideas and products.

### SUMMARY OF THE INVENTION

A disclosed plant identification (PID) pin includes a push pin flat stock base having a central ratchet defining a hole for a pin and defining a screen for an identification number. A knob includes a pointer and defines an opening coincident with the flat stock base hole and configured complementary to the central ratchet. A partial disk rotates around the pin and includes an identification number (IDN) on a face thereof and a boss coincident with the flat stock base hole. Additionally, a pin is designed to push through the flat stock base, the boss of the partial disk and into a tree and anchor the push pin into a woody stock of a plant. The disclosure also has broad application to any type of woody tissue, and anything that uses a scan code including alpha, numeric and alphanumeric codes with any type of digital software and attachable via any type of mechanical, adhesive and other attachment means included. The disclosure also includes a backup recovery code in case the scan is ever damaged or compromised.

The disclosed method includes defining 110 a screen for an identification number via a push pin flat stock base having a central ratchet defining a hole for a pin. The method also includes disposing 120 a knob having a pointer and defining an opening coincident with the flat stock base hole and configured complementary to the central ratchet. The method additionally includes attaching 130 a partial disk having an identification number (IDN) on a face thereof and a boss coincident with the flat stock base hole configured to rotate around the pin. The method further includes pushing 140 a pin through the flat stock base, the boss of the partial disk and into a tree and anchor the push pin into a woody stock of a plant.

### BRIEF DESCRIPTION OF THE DRAWINGS

FIG. 1 depicts a top down view of the tree GPS tagging and app device in accordance with an embodiment of the present disclosure.

FIG. 2 depicts an underside view of the tree GPS tagging and app device in accordance with an embodiment of the present invention.

FIG. 3 is a block diagram of a method of tree identification in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term ‘pin’ is used synonymously with nail and fastener in the common sense. The term ‘woody’ refers to the bark of a tree and to a thick trunk of a bush or brush and also to wood poles used for telephone and electricity transmission.

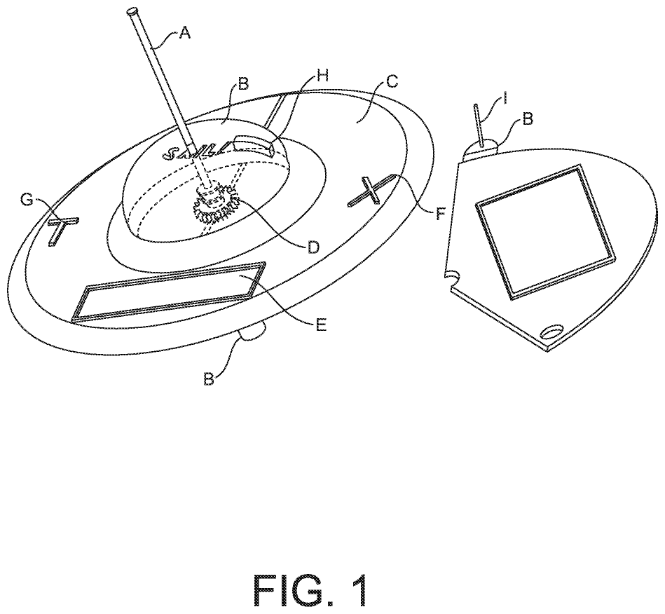

FIG. 1 depicts a top perspective view of the tree GPS tagging and app device in accordance with an embodiment of the present disclosure. The device is a three inch in diameter flat disc of biodegradable plastic with a pin/reader extending from the center top of the disc at a 90 degree angle. The product also includes a screen to display the 4 digit numeric code on the top portion of the disc. The numeric code will be entered into a search field on an app used by the forestry services. The top portion of the disc will additionally have two markers: T for trim, X for remove. These markers indicate what action to perform on the located tree. The method of use is to push the product into the tree and enter the 4 digit code to identify the tree.

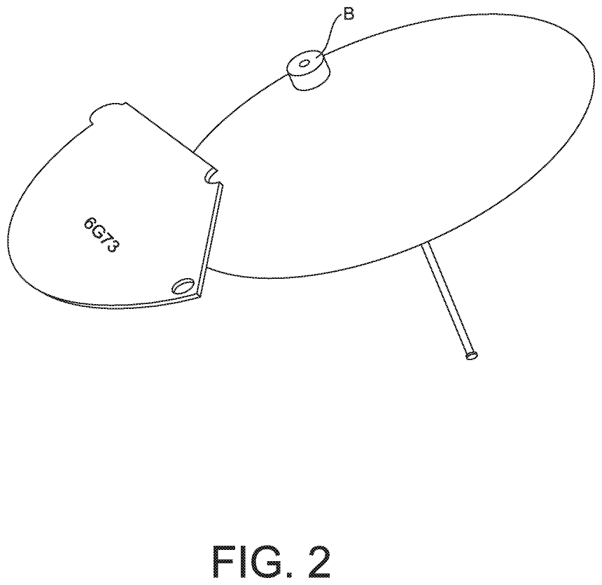

FIG. 2 depicts an underside perspective view of the tree GPS tagging and app device in accordance with an embodiment of the present invention. In the center of the disc is a knob. User turns knob to T for trim or X for Remove. A spring loaded brad nailer pushes the nail into the tree The device will have a QR code on it, when this code is scanned (all types of scanning including: Phone camera/rfid reader/barcode/QR code/NFC), it will activate the point on the Collector app that belongs to that tree. Collector app is GPS mapping software that holds the work information and location of trees or other disaster sites needed to be worked. User may also enter the 4 digit alpha numeric code into collector.

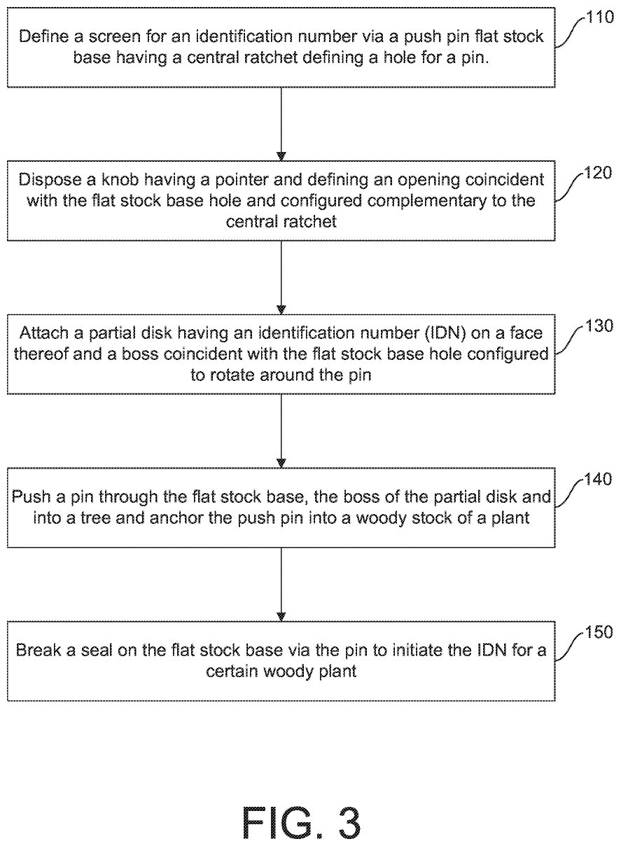

FIG. 3 is a block diagram of a method of tree identification in accordance with an embodiment of the present disclosure. The method includes defining 110 a screen for an identification number via a push pin flat stock base having a central ratchet defining a hole for a pin. The method also includes disposing 120 a knob having a pointer and defining an opening coincident with the flat stock base hole and configured complementary to the central ratchet. The method additionally includes attaching 130 a partial disk having an identification number (IDN) on a face thereof and a boss coincident with the flat stock base hole configured to rotate around the pin. The method further includes pushing 140 a pin through the flat stock base, the boss of the partial disk and into a tree and anchor the push pin into a woody stock of a plant.

The backup recovery code is created by error recovery methods including error correction coding and redundancy coding. A backup recovery code is stored electronically and is matched with a fully or partially rebuilt damaged scan code. The electronic copy is held in device memory and in system memory so there are multiple copies for rebuilding a damaged scan code.

Embodiments of the disclosure are used for identifying other things such as property lines, towers, etc. in addition to plants and trees. The disclosure is also not limited to a 4 digit identification number, but includes any number of digits, alphanumeric and characters codes as well. Also the way it is affixed to a tree or an object is unlimited including embodiments herein and reasonable teachings and suggestions including hose of ordinary skill in the present art and future developments.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein in a non-provisional specification to follow.

What is claimed is:

1. An identification (ID) pin, comprising:
a push pin flat stock base having a central ratchet defining a hole for a pin and defining a screen for an identification number;
a knob having a pointer and defining an opening coincident with the flat stock base hole and configured complementary to the central ratchet;
a partial disk having an identification number (IDN) on a face thereof and a boss coincident with the flat stock base hole configured to rotate around the pin;
a pin configured to push through the flat stock base, the boss of the partial disk and into a tree and anchor the push pin into a woody stock of a plant.

2. The ID pin of claim 1, wherein the flat stock base has a “T,” and an “X,” indicia on a face thereof for the knob pointer to indicate ‘trim,’ or ‘remove.’

3. The ID pin of claim 1, wherein the flat stock base screen is an opening in the flat stock base for the IDN of the partial disk to be seen there through.

4. The ID pin of claim 1, wherein the knob includes a complementary ratchet mechanism for engaging with the ratchet mechanism of the flat stock base.

5. The ID pin of claim 1, further comprising an electronically stored backup code used for matching with a recovered IDN built by error recovery methods including error correction coding and redundancy coding.

6. The ID pin of claim 1, wherein the partial disk comprises a radius equal to a radius of the flat stock base.

7. The ID pin of claim 1, wherein the partial disk further comprises an extension configured to extend beyond a radius of the flat stock base and define an opening for a nail.

8. The ID pin of claim 1, wherein the pin comprises a barbed end configured to anchor the PID pin into the woody stock of a plant such as a tree and a woody bush.

9. The ID pin of claim 1, further comprising a passive electronic identification circuit configured with the identification number to respond to GPS (Global Positioning Satellite) location queries.

10. An identification method comprising:
defining a screen for an identification number via a push pin flat stock base having a central ratchet defining a hole for a pin;
disposing a knob having a pointer and defining an opening coincident with the flat stock base hole and configured complementary to the central ratchet;
attaching a partial disk having an identification number (IDN) on a face thereof and a boss coincident with the flat stock base hole configured to rotate around the pin; and
pushing a pin through the flat stock base, the boss of the partial disk and into a tree and anchor the push pin into a woody stock of a plant.

11. The method of claim 10, further comprising communicating with other devices via a wired and a wireless communications port circuitry in the push pin.

12. The method of claim 10, further comprising marking the flat stock base with a “T,” and an “X,” indicia on a face thereof for the knob pointer to indicate ‘trim,’ or ‘remove.’

13. The method of claim 10, further comprising defining a screen in the flat stock base screen via an opening in the flat stock base for the IDN of the partial disk to be seen there through.

14. The method of claim 10, further comprising engaging the knob via a complementary ratchet mechanism with the ratchet mechanism of the flat stock base.

15. The method of claim 10, further comprising building a recovered IDN by error recovery methods including error correction coding and redundancy for matching to an electronically stored backup code at a device or system level.

16. The method of claim 10, further comprising forming a radius for the partial disk equal to a radius of the flat stock base.

17. The method of claim 10, fixing an IDN in the screen from the partial disk via nailing an extension extending beyond a radius of the flat stock base into the woody stock.

18. The method of claim 10, further comprising anchoring the PID pin into the woody stock via a barbed end thereof.

19. The method of claim 10, further comprising configuring a passive electronic identification circuit with the identification number to respond to GPS (Global Positioning Satellite) location queries.

20. The method of claim 10 further comprising breaking a seal on the flat stock base via the pin to initiate the IDN for a certain woody plant.
